(19) United States
(12) Patent Application Publication
(10) Pub. No.: US 2025/0236460 A1
(43) Pub. Date: Jul. 24, 2025

(54) PLATFORM VEHICLE AND METHODS OF OPERATING THE SAME

(71) Applicant: Y.E. Hub Armenia LLC, Yerevan (AM)

(72) Inventor: Andrei SHPILKOVSKII, Moscow (RU)

(21) Appl. No.: 19/027,980

(22) Filed: Jan. 17, 2025

(30) Foreign Application Priority Data
Jan. 18, 2024 (RU) 2024101196

(51) Int. Cl. B65G 1/04; B65G 1/06

(52) U.S. Cl. CPC B65G 1/0492; B65G 1/065

(57) ABSTRACT

There is provided a platform vehicle for a robotic system of a warehouse, the platform vehicle configured to vertically traverse racks of the warehouse. The platform vehicle comprising a first engagement assembly configured to selectively engage a first rack of the two racks; a second engagement assembly configured to selectively engage a second rack; a longitudinal guide configured to guide the first engagement assembly and the second engagement assembly; and a transverse guide system.

### CROSS-REFERENCE

The present application claims priority to Russian Patent Application No. 2024101196, entitled “Platform Vehicle and Methods of Operating the Same”, filed Jan. 18, 2024, the entirety of which is incorporated herein by reference.

### FIELD

The present technology generally relates to platform vehicles for robotic systems of a warehouse and methods of operating the same.

### BACKGROUND

Robotic vehicles are widely used across an array of industries for various purposes, such as for conducting visual surveys, and transporting various items. In some instances, for example, robotic vehicles can be used to move items stored in a warehouse.

Some robotic vehicles can be programmed to follow predefined routes or utilize markers for navigation on a warehouse floor. Other robot vehicles can be equipped with additional systems to adapt “autonomously” to changes in the warehouse layout or real-time obstacles, thus increasing their overall effectiveness and safety in managing warehouse logistics.

In some instances, these robotic vehicles comprise a lower part and a removably attached upper part, where the lower part comprises wheels to move the robotic vehicle around on the floor of the warehouse and the upper part configured to move in a vertical direction by connecting to, for example, rails of warehouse racks. The upper part may therefore retrieve goods located on the warehouse racks.

However, as the warehouse racks may be inclined/skewed (due to inaccurate placement, overloading, etc.), the robotic vehicles, and in particular the upper parts thereof, may not be able to correctly attach to the warehouse racks and correctly move in a vertical direction even if attached thereto.

### SUMMARY

It is an object of the present technology to ameliorate at least some of the inconveniences noted above.

In a broad aspect of the present technology, there is provided a platform vehicle for a robotic system of a warehouse, the platform vehicle configured to vertically traverse racks of the warehouse, the platform vehicle comprising: a platform defining a longitudinal direction and a transverse direction, the platform being moveable vertically up and down two racks of the warehouse disposed on opposite sides of the platform and spaced apart along the longitudinal direction; and an engagement system configured to engage with the two racks of the warehouse, the engagement system comprising: a first engagement assembly configured to selectively engage a first rack engagement of a first rack of the two racks; a second engagement assembly configured to selectively engage a second rack engagement of a second rack of the two racks, the first engagement assembly and the second engagement assembly being disposed on opposite sides of the platform and spaced apart along the longitudinal direction; a longitudinal guide configured to guide the first engagement assembly and the second engagement assembly along the longitudinal direction of the platform; a longitudinal spacing drive assembly configured to selectively drive the first engagement assembly and the second engagement assembly along the longitudinal guide such that the first engagement assembly and the second engagement assembly are moveable between a first spacing configuration and a second spacing configuration, a longitudinal distance between the first engagement assembly and the second engagement assembly being greater in the second spacing configuration than in the first spacing configuration, the first engagement assembly and the first rack engagement being engageable in the second spacing configuration and the second engagement assembly and the second rack engagement being engageable in the second spacing configuration; and a transverse guide system configured to guide the first engagement assembly along the transverse direction of the platform and the second engagement assembly along the transverse direction of the platform, the transverse guide system being configured such that: i) whilst the first engagement assembly and the first rack engagement are engaged and the platform vehicle traverses vertically, the first engagement assembly is moveable along the transverse guide system in reaction to displacement in the transverse direction of the first rack engagement; and ii) whilst the second engagement assembly and the second rack engagement are engaged and the platform vehicle traverses vertically, the second engagement assembly is moveable along the transverse guide system in reaction to displacement in the transverse direction of the second rack engagement.

In some embodiments, the transverse guide system is configured to guide the first engagement assembly along a first linear path in the transverse direction of the platform and the second engagement assembly along a second linear path in the transverse direction of the platform, the first linear path and the second linear path being spaced apart along the longitudinal direction.

In some embodiments, the first and/or second engagement assembly comprises at least one guide recess receiving a corresponding guide rail of the transverse guide system.

In some embodiments, the first and/or second engagement assembly comprises at least one guide rail received in a corresponding guide recess of the transverse guide system.

In some embodiments, the transverse guide system comprises: a first transverse guide assembly configured to guide the first engagement assembly along the transverse direction of the platform, the first transverse guide assembly being configured such that whilst the first engagement assembly and the first rack engagement are engaged and the platform vehicle traverses vertically, the first engagement assembly is moveable along the first transverse guide assembly in reaction to displacement in the transverse direction of the first rack engagement; and a second transverse guide assembly configured to guide the second engagement assembly along the transverse direction of the platform, the second transverse guide assembly being configured such that whilst the second engagement assembly and the second rack engagement are engaged and the platform vehicle traverses vertically, the second engagement assembly is moveable along the second transverse guide assembly in reaction to displacement in the transverse direction of the second rack engagement.

In some embodiments, the longitudinal spacing drive assembly is configured to selectively drive the first engagement assembly and the second engagement assembly from the first spacing configuration to the second spacing configuration and configured to detect engagement of both the first engagement assembly with the first rack engagement and the second engagement assembly with the second rack engagement, and wherein upon detection of both, the longitudinal spacing drive assembly is configured to stop driving the first engagement assembly and the second engagement assembly between the first spacing configuration and the second spacing configuration.

In some embodiments, the longitudinal spacing drive assembly is configured such that when the longitudinal spacing drive assembly is not driving the first engagement assembly and the second engagement assembly between the first spacing configuration and the second spacing configuration, the first engagement assembly and the second engagement assembly are free to move between the first spacing configuration and the second spacing configuration in reaction to displacement in the longitudinal direction of the first rack engagement and/or the second rack engagement whilst the platform vehicle vertically traverses the two racks.

In some embodiments, the longitudinal spacing drive assembly is configured to detect engagement of the first engagement assembly with the first rack engagement and/or the second engagement assembly with the second rack engagement using at least one induction detector arranged to detect the presence of the respective rack engagement.

In some embodiments, the longitudinal spacing drive assembly comprises a ball-screw transmission configured to selectively drive the first engagement assembly and the second engagement assembly between the first spacing configuration and the second spacing configuration.

In some embodiments, the ball-screw transmission comprises a rod with two opposing screw threads, and wherein the first engagement assembly is driven by one of the opposing screw threads and the second engagement assembly is driven in the opposite direction by the other opposing screw thread.

In some embodiments, the first rack engagement and/or the second rack engagement is a linear gear, and wherein the corresponding first engagement assembly and/or the second engagement assembly comprises at least one pinion configured to engage the corresponding linear gear.

In some embodiments, the longitudinal guide and the transverse guide system operate independently from each other.

According to another broad aspect of the present technology, there is provided a method of vertically traversing racks of a warehouse with a platform vehicle of a robotic system, the platform vehicle comprising a platform defining a longitudinal direction and a transverse direction, the method comprising: positioning the platform between two racks of the warehouse such that the two racks are disposed on opposite sides of the platform and spaced apart along the longitudinal direction; extending, in the longitudinal direction, a first engagement assembly and a second engagement assembly of the platform vehicle along a longitudinal guide of the platform vehicle from a first spacing configuration to a second spacing configuration; engaging the first engagement assembly and a first rack engagement of a first rack of the two racks in the second spacing configuration and engaging the second engagement assembly and a second rack engagement of a second rack of the two racks in the second spacing configuration; moving the platform vehicle vertically with respect to the two racks such that the first engagement assembly and/or the second engagement assembly are moved, in the transverse direction, along a transverse guide system of the platform vehicle in reaction to displacement in the transverse direction of the first rack engagement and/or the second rack engagement.

In some embodiments, the transverse guide system guides the first engagement assembly along a first linear path in the transverse direction of the platform and the second engagement assembly along a second linear path in the transverse direction of the platform, the first linear path and the second linear path being spaced apart along the longitudinal direction.

In some embodiments, the first and/or second engagement assembly comprises at least one guide recess receiving a corresponding guide rail of the transverse guide system.

In some embodiments, the first and/or second engagement assembly comprises at least one guide rail received in a corresponding guide recess of the transverse guide system.

In some embodiments, once the first engagement assembly and the first rack engagement are engaged and once the second engagement assembly and the second rack engagement are engaged, the longitudinal and transverse positions of the first engagement assembly and the second engagement assembly are free to change in reaction to the longitudinal and transverse positions of the first rack engagement and the second rack engagement.

In some embodiments, once the first engagement assembly and the first rack engagement are engaged and once the second engagement assembly and the second rack engagement are engaged, the longitudinal and transverse positions of the first engagement assembly and the second engagement assembly are dictated solely by the longitudinal and transverse positions of the first rack engagement and the second rack engagement.

In some embodiments, the first rack engagement and/or the second rack engagement is a linear gear, and wherein the corresponding first engagement assembly and/or the second engagement assembly comprises at least one pinion configured to engage the corresponding linear gear.

In some embodiments, the longitudinal guide and the transverse guide system operate independently from each other.

In a further broad aspect of the present technology, there is provided a platform vehicle for a robotic system of a warehouse, the platform vehicle configured to vertically traverse racks of the warehouse, the platform vehicle comprising: a platform defining a center, a longitudinal direction and a transverse direction, the platform being moveable vertically up and down two racks of the warehouse disposed on opposite sides of the platform and spaced apart along the longitudinal direction; and an engagement system configured to engage the two racks of the warehouse, the engagement system comprising: a first engagement assembly configured to selectively engage a first rack engagement of a first rack of the two racks and configured to be moveable between a neutral position and at least one extended position, the at least one extended position of the first engagement assembly being offset from the neutral position in both the longitudinal direction and the transverse direction; a second engagement assembly configured to selectively engage a second rack engagement of a second rack of the two racks and configured to be moveable between a neutral position and at least one extended position, the at least one extended position of the second engagement assembly being offset from the neutral position in both the longitudinal direction and the transverse direction; a first cam guide configured to constrain the movement of the first engagement assembly such that, as the first engagement assembly is moved towards its neutral position in the longitudinal direction, the first cam guide guides the first engagement assembly towards its neutral position in the transverse direction; and a second cam guide configured to constrain the movement of the second engagement assembly such that as the second engagement assembly is moved towards its neutral position in the longitudinal direction, the second cam guide guides the second engagement assembly towards its neutral position in the transverse direction.

In some embodiments, the neutral position of the first engagement assembly and the neutral position of the second engagement assembly are aligned in the transverse direction.

In some embodiments, the neutral position of the first engagement assembly and the neutral position of the second engagement assembly are oppositely offset equally in the longitudinal direction from the center of the platform.

In some embodiments, the first cam guide and/or the second cam guide transversely narrows closer to the center of the platform.

In some embodiments, the first cam guide and/or the second cam guide is transversely widest at a longitudinal position furthest from the center of the platform.

In some embodiments, the first cam guide and the second cam guide are symmetrical with each other across a line of symmetry parallel to the transverse direction and through the center of the platform.

In some embodiments, the first cam guide is transversely narrower than the second cam guide at a furthest longitudinal position of each respective cam guide.

In some embodiments, the first cam guide is configured such that for any longitudinal position of the first engagement assembly, the transverse position of the first engagement assembly is limited to a corresponding single position.

In some embodiments, the engagement system comprises a longitudinal guide configured to guide the first engagement assembly and the second engagement assembly along the longitudinal direction of the platform between the respective neutral positions and respective maximum longitudinal extended positions, and wherein the first cam guide and the second cam guide is widest at the respective maximum longitudinal extended positions.

In some embodiments, wherein the engagement system comprises a transverse guide system configured to guide the first engagement assembly and the second engagement assembly along the transverse direction of the platform between the respective neutral positions and respective maximum transverse extended positions, wherein the width of the first cam guide and/or the second cam guide at a longitudinal position furthest from the center of the platform defines a transverse width which is configured such that the first cam guide and/or second cam guide covers all possible transverse positions of the respective cam guide.

In some embodiments, the engagement system comprises: a third engagement assembly configured to selectively engage a third rack engagement of the first rack and configured to be moveable between a neutral position and at least one extended position, the at least one extended position of the third engagement assembly being offset from the neutral position in both the longitudinal direction and the transverse direction; a fourth engagement assembly configured to selectively engage a fourth rack engagement of the second rack and configured to be moveable between a neutral position and at least one extended position, the at least one extended position of the fourth engagement assembly being offset from the neutral position in both the longitudinal direction and the transverse direction; a third cam guide configured to constrain the movement of the third engagement assembly such that, as the third engagement assembly is moved towards its neutral position in the longitudinal direction, the third cam guide guides the third engagement assembly towards its neutral position in the transverse direction; and a fourth cam guide configured to constrain the movement of the fourth engagement assembly such that as the fourth engagement assembly is moved towards its neutral position in the longitudinal direction, the fourth cam guide guides the fourth engagement assembly towards its neutral position in the transverse direction.

In some embodiments, the first cam guide and/or the second cam guide is a groove or slot, and wherein the first engagement assembly and/or the second engagement assembly comprises a protrusion or roller to engage the respective cam guide.

In some embodiments, the first cam guide is transversely narrower than the second cam guide at a furthest longitudinal position of each respective cam guide, wherein the third cam guide and the fourth cam guide are symmetrical with each other across a line of symmetry parallel to the transverse direction and through the center of the platform, and wherein second cam guide and the fourth cam guide are symmetrical with each other across a line of symmetry parallel to the longitudinal direction and through the center of the platform.

In another broad aspect, there is provided a method of operating a platform vehicle for a robotic system of a warehouse, the platform vehicle configured to vertically traverse racks of the warehouse, the platform vehicle comprising a platform which defines a longitudinal direction and a transverse direction, the method comprising: retracting, in the longitudinal direction, a first engagement assembly from an extended position to a neutral position so that a first cam guide constrains the movement of the first engagement assembly such that as the first engagement assembly is moved towards its neutral position in the longitudinal direction, the first cam guide guides the first engagement assembly towards its neutral position in the transverse direction; and retracting, in the longitudinal direction, a second engagement assembly from an extended position to a neutral position so that a second cam guide constrains the movement of the second engagement assembly such that as the second engagement assembly is moved towards its neutral position in the longitudinal direction, the second cam guide guides the second engagement assembly towards its neutral position in the transverse direction.

In some embodiments, the method comprises, after retracting the first engagement assembly, extending the first engagement assembly from the neutral position to a second extended position; after extending the first engagement assembly, retracting, in the longitudinal direction, the first engagement assembly from the second extended position to the neutral position so that a first cam guide constrains the movement of the first engagement assembly such that as the first engagement assembly is moved towards its neutral position in the longitudinal direction, the first cam guide guides the first engagement assembly towards its neutral position in the transverse direction; after retracting the second engagement assembly, extending the second engagement assembly from the neutral position to a third extended position; and after extending the second engagement assembly, retracting, in the longitudinal direction, the second engagement assembly from the third extended position to the neutral position so that a second cam guide constrains the movement of the second engagement assembly such that as the second engagement assembly is moved towards its neutral position in the longitudinal direction, the second cam guide guides the second engagement assembly towards its neutral position in the transverse direction.

In some embodiments, the extended position of the first engagement assembly is different from the second extended position of the first engagement assembly, and/or wherein the extended position of the second engagement assembly is different from the third extended position of the second engagement assembly.

Features of any aspect disclosed herein and the exemplary embodiments thereof may be combined freely with any other aspect and the exemplary embodiments thereof. For example, any of the features of the guide rails (and features associated therewith) may be freely combined with any features of the cam guides (and features associated therewith).

For purposes of this specification, terms related to spatial orientation such as forwardly, rearwardly, upwardly, downwardly, left, and right, are as they would normally be understood by a user or operator of the robotic vehicle. Terms related to spatial orientation when describing or referring to components or sub-assemblies of the device, separately from the device should be understood as they would be understood when these components or sub-assemblies are mounted to the device.

Implementations of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

The above-noted aspects and embodiments may be freely combined with each other.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a plan view schematic representation of a warehouse with racks and robotic vehicles;

FIG. 2 depicts a side view schematic representation of a robotic vehicle between two racks of the warehouse of FIG. 1;

FIG. 3 depicts a perspective view of a platform vehicle of a robotic vehicle, in accordance with certain non-limiting embodiments of the present technology;

FIG. 4 depicts a perspective view of the platform vehicle of FIG. 3 with certain elements removed to show four engagement assemblies thereof, in accordance with certain non-limiting embodiments of the present technology;

FIG. 5 depicts a perspective view of the platform vehicle of FIG. 3 with further elements removed to show a longitudinal spacing drive assembly thereof, in accordance with certain non-limiting embodiments of the present technology;

FIG. 6 depicts an isolated perspective view of two engagement assemblies of the platform vehicle of FIG. 3 together with a longitudinal guide and a longitudinal spacing drive assembly, in accordance with certain non-limiting embodiments of the present technology;

FIG. 7 depicts an isolated perspective view of the engagement assembly of FIG. 6 with corresponding transverse guide and longitudinal guide, in accordance with certain non-limiting embodiments of the present technology;

FIG. 8 depicts an isolated perspective view of an engagement assembly of the platform vehicle of FIG. 3, in accordance with certain non-limiting embodiments of the present technology;

FIG. 9 depicts an isolated perspective view of the engagement assembly of FIG. 6 with corresponding transverse guide, longitudinal guide and cam guide, in accordance with certain non-limiting embodiments of the present technology;

FIG. 10 depicts four cam guides of the platform vehicle of FIG. 3, in accordance with certain non-limiting embodiments of the present technology; and

FIGS. 11A and 11B depict detailed views of two different cam guides of the platform vehicle of FIG. 3, in accordance with certain non-limiting embodiments of the present technology.

### DETAILED DESCRIPTION

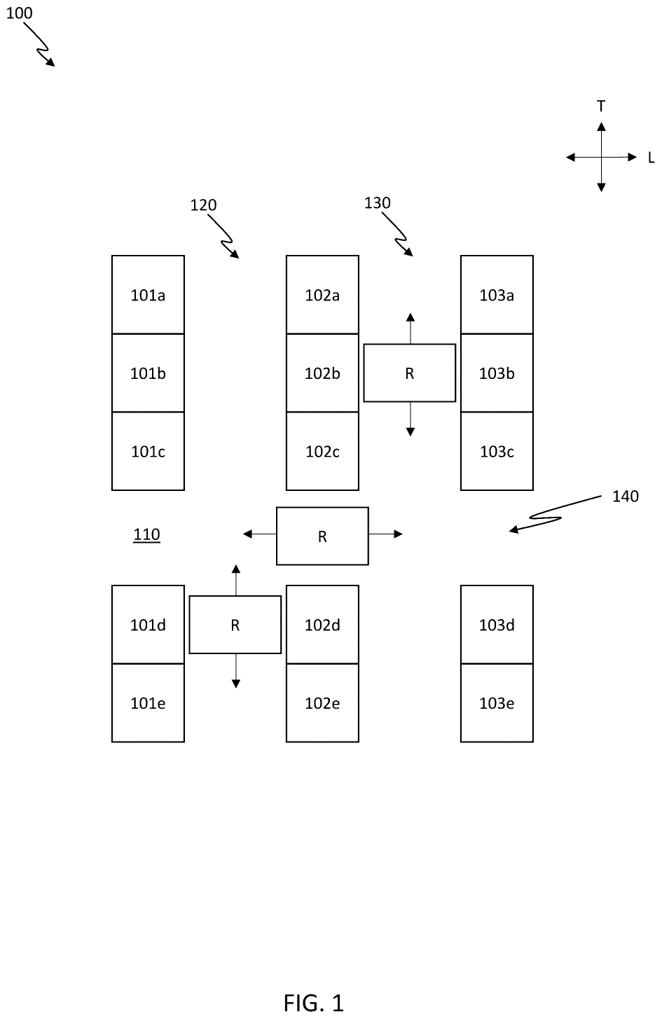

With reference to FIG. 1, there is depicted a plan view schematic representation of a warehouse 100 with racks 101a, 101b, etc., 102a, 102b etc., 103a, 103b, etc. (referred to as racks 101, 102, 103 herein) and three robotic vehicles R. As shown in FIG. 1 as a non-limiting example, the racks 101, 102, 103 may be arranged in lines with aisles 120, 130, 140 therebetween. As would be understood by those skilled in the art, any number/arrangement of racks 101, 102, 103 and robotic vehicles R may be used.

The robotic vehicles R may move between the racks 101, 102, 103 by horizontally traversing through the aisles 120, 130, 140 on floor 110 of warehouse 100. As detailed further below, each robotic vehicle R defines a longitudinal direction L and a transverse direction T. Generally, due to the normal orientation of the robotic vehicles, the longitudinal direction L and the transverse direction T may be considered as being fixed relative to the warehouse 100 in the manner shown in FIG. 1.

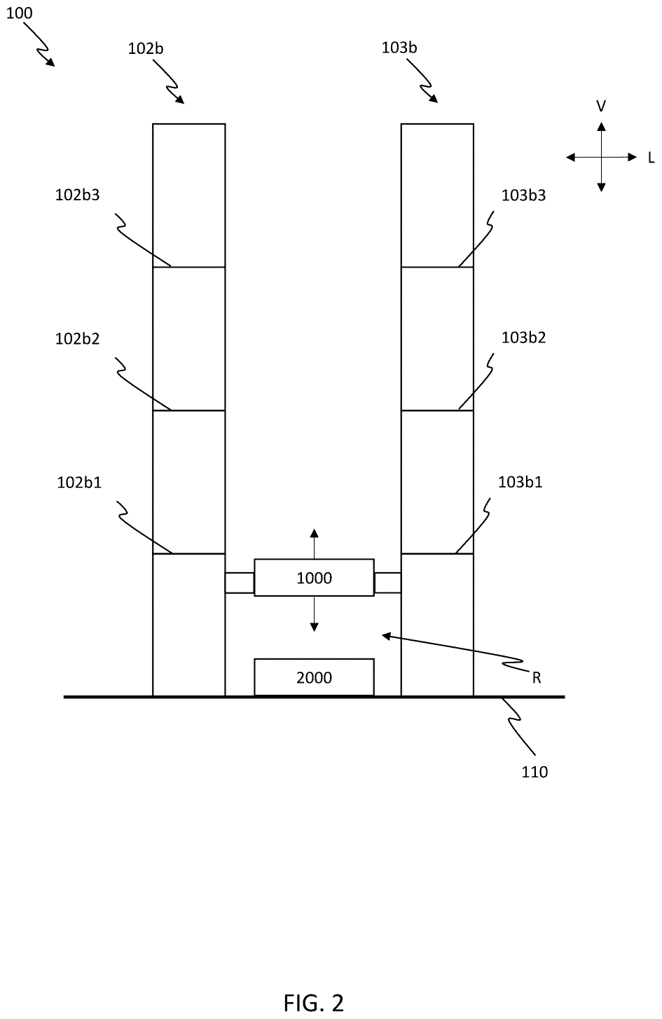

With reference to FIG. 2, there is depicted a side view schematic representation of the robotic vehicle R between the two racks 102b, 103b shown in FIG. 1. As can be seen in FIG. 2, rack 102b comprises three shelves/levels 102b1, 102b2, 102b3 on which goods may be stored. Similarly, rack 103b also comprises three shelves/levels 103b1, 103b2, 103b3 on which further goods may be stored. As would be understood by those skilled in the art, the racks 102b, 103b may contain any number of shelves/levels and may contain a different number of shelves/levels to each other.

The robotic vehicle R is positioned between the two racks 102b, 103b (in the aisle 130 of warehouse 100). The two racks 102b, 103b are disposed on opposite sides of the robotic vehicle R such that the two racks 102b, 103b are spaced apart along the longitudinal direction L of the robotic vehicle R.

The robotic vehicle R comprises an upper part 1000 (referred to as a platform vehicle 1000 herein) removably attachable to the lower part 2000. The lower part 2000 may comprise wheels (not shown) such that the robotic vehicle R (including both the upper part 1000 and lower part 2000) may horizontally traverse the floor 110 of the warehouse 100 (e.g. to relocate between specific racks 101, 102, 103 and/or to transport goods).

FIG. 2 shows the robotic vehicle R in a configuration where the platform vehicle 1000 has detached from the lower part 2000 and has climbed the racks 102b, 103b in a vertical direction V. As would be understood by those skilled in the art, and as detailed further below, the platform vehicle 1000 may selectively engage rails (not shown) of the racks 102b, 103b such that it may propel itself up and down the racks 102b, 103b.

Once the platform vehicle 1000 is positioned at the desired shelf/level of rack 102b or rack 103b, it may retrieve goods (e.g. by a grabbing arm, not shown) from the shelf/level and place them on itself. Thereafter, the platform vehicle 1000 may descend in the vertical direction V and reattach to the lower part 2000 such that the goods may be transported horizontally through the warehouse 100 by the robotic vehicle R.

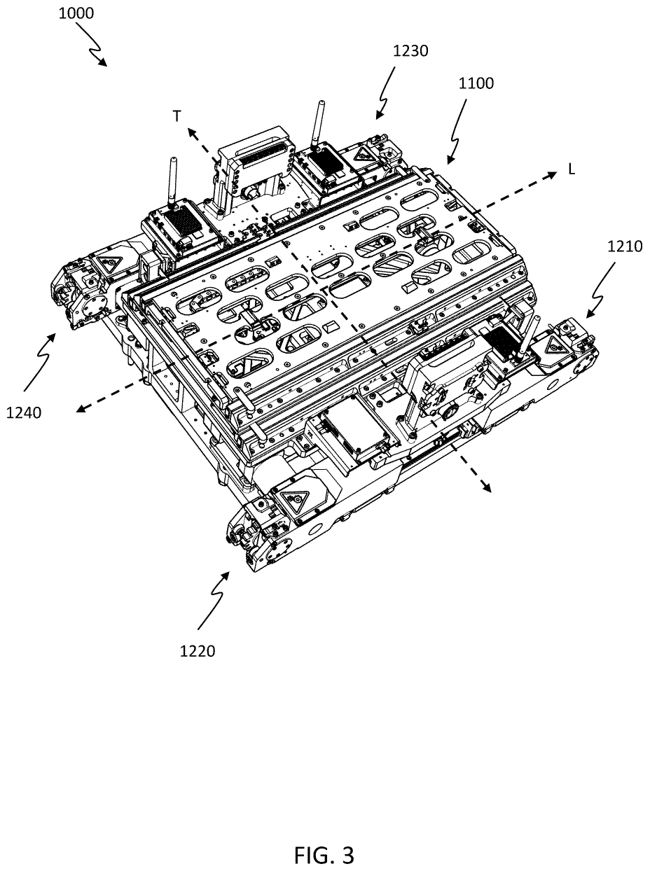

FIG. 3 depicts a perspective view of the platform vehicle 1000 of the robotic vehicle R, in accordance with certain non-limiting embodiments of the present technology.

The platform vehicle 1000 is configured to be positioned between two racks (e.g. rack 102b and rack 103b shown in FIGS. 1 and 2), such that the racks 102b, 103b are disposed on opposite sides of the platform vehicle 1000 and spaced apart along a longitudinal direction L of the platform vehicle 1000. Due to the shape of the aisles typical in warehouses and to maximise the goods carrying capacity of robotic vehicles R, the platform vehicle 1000 may typically be generally rectangular in plan-view shape and configured such that, in use, it is positioned with racks 102b, 103b generally parallel with the shorter sides of the rectangular shape. In this manner, the platform vehicle 1000 defines a longitudinal direction L (e.g. the longitudinal axis of the rectangular shape) and a transverse direction T (e.g. the transverse axis of the rectangular shape). However, as would be understood by those skilled in the art, any shape of platform vehicle 1000 may be used, and, in any case, the longitudinal direction L is to be understood as being the direction spanning between the two opposite racks 102b, 103b, and the transverse direction T being perpendicular to the longitudinal direction (and generally parallel to the floor 110 of the warehouse 100).

As shown in FIG. 3, the platform vehicle 1000 comprises a platform 1100 which defines a longitudinal direction L and a transverse direction T in a similar manner to the platform vehicle 1000. The platform 1100 may be generally planar and/or flat. The platform 1100 may be used to hold goods thereon, as would be understood by those skilled in the art. The platform 1100 also may define the main body of the platform vehicle 1000.

The platform 1100 may have other components of the platform vehicle 1000 attached thereto, many of which are not described in detail herein due to them being known to those skilled in the art.

The present novel technology particularly relates to the manner in which platform vehicle 1000 attaches to racks 101, 102, 103 of the warehouse 100. In particular, the platform vehicle 1000 comprises four engagement assemblies 1210, 1220, 1230, 1240 (which form part of an engagement system further defined below). As further detailed below, the four engagement assemblies 1210, 1220, 1230, 1240 are each configured to engage racks 101, 102, 103 of the warehouse 100.

The first engagement assembly 1210 and the second engagement assembly 1220 are disposed on opposite sides of the platform 1100 to each other and are spaced apart in the longitudinal direction L thereof. Similarly, the third engagement assembly 1230 and the fourth engagement assembly 1240 are disposed on opposite sides of the platform 1100 to each other and are spaced apart in the longitudinal direction L thereof. The first engagement assembly 1210 and the second engagement assembly 1220 are spaced apart from third engagement assembly 1230 and the fourth engagement assembly 1240 in the transverse direction T of the platform 1100. Generally, the four engagement assemblies 1210, 1220, 1230, 1240 are disposed at the four corners of the platform 1100.

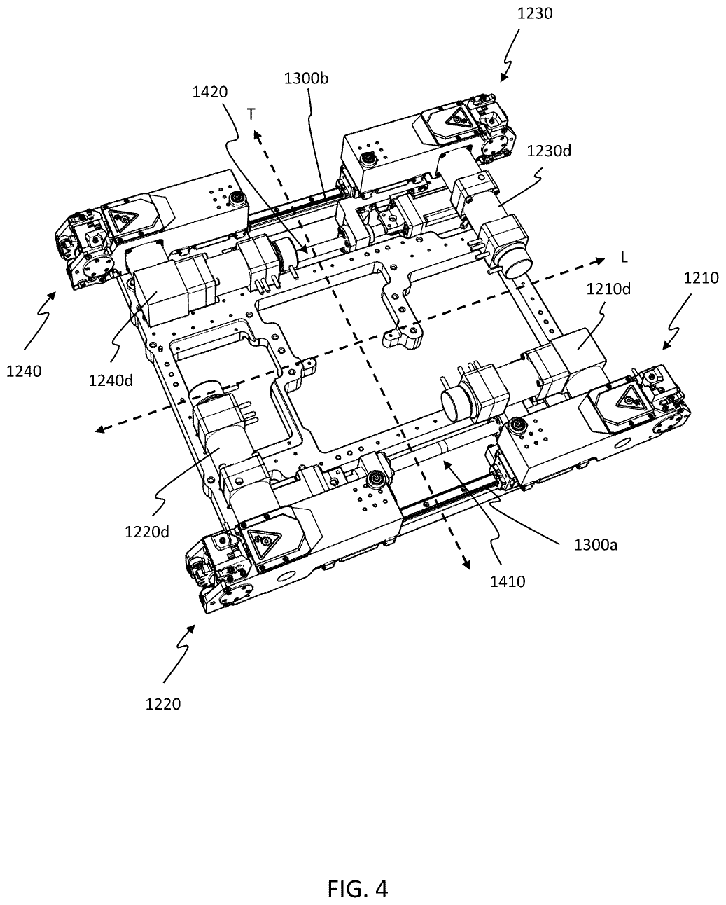

FIG. 4 depicts a perspective view of the platform vehicle 1000 of FIG. 3 with certain elements removed (including the platform 1100), which shows a clearer view of the four engagement assemblies 1210, 1220, 1230, 1240.

As can be seen in FIG. 4, the platform vehicle 1000 comprises a first longitudinal guide rail 1300a. The first longitudinal guide rail 1300a generally extends in the longitudinal direction L. The first longitudinal guide rail 1300a is in a fixed relative position to the platform 1100. The first engagement assembly 1210 and the second engagement assembly 1220 are disposed on the first longitudinal guide rail 1300a. The first engagement assembly 1210 and the second engagement assembly 1220 are each moveable along the first longitudinal guide rail 1300a. Accordingly, each of the first engagement assembly 1210 and the second engagement assembly 1220 may be moved relative to the platform 1100 along the longitudinal direction L.

The platform vehicle 1000 further comprises a first longitudinal spacing drive assembly 1410. As further detailed below, the first longitudinal spacing drive assembly 1410 is connected to each of the first engagement assembly 1210 and the second engagement assembly 1220 and is configured to selectively move the first engagement assembly 1210 and the second engagement assembly 1220 along the first longitudinal guide rail 1300a (in the longitudinal direction L).

Specifically, the first longitudinal spacing drive assembly 1410 is configured to selectively drive the first engagement assembly 1210 along the first longitudinal guide rail 1300a such that the first engagement assembly 1210 is moveable between a neutral position (also referred to as a retracted position) and an extended position. Similarly, the longitudinal spacing drive assembly 1410 is configured to selectively drive the second engagement assembly 1220 along the first longitudinal guide rail 1300a such that the second engagement assembly 1220 is moveable between a neutral position (also referred to as a retracted position) and an extended position.

As detailed below, the first longitudinal spacing drive assembly 1410 is configured to selectively drive both the first engagement assembly 1210 and the second engagement assembly 1220 at the same time. In particular, the longitudinal spacing drive assembly 1410 is configured such that each of the first engagement assembly 1210 and the second engagement assembly 1220 are moved in an approximately equal distance upon being driven by the longitudinal spacing drive assembly 1410. In certain embodiments, the first engagement assembly 1210 and the second engagement assembly 1220 are configured to maintain an equal longitudinal distance from a central point (e.g. a centre line of the platform 1100).

With such a configuration, the longitudinal spacing drive assembly 1410 is configured to selectively drive the first engagement assembly 1210 and the second engagement assembly 1220 along the first longitudinal guide rail 1300a such that the first engagement assembly 1210 and the second engagement assembly 1220 are moveable between a first spacing configuration and a second spacing configuration. A longitudinal distance (along the longitudinal direction L) between the first engagement assembly 1210 and the second engagement assembly 1220 may be greater in the second spacing configuration than in the first spacing configuration.

While in the extended position (or in the second configuration), the first engagement assembly 1210 is configured to be engageable with a first rack engagement (not shown) of a first rack. Once engaged with the first rack engagement, a first drive motor 1210d may be selectively activated to apply an upward or downward force on the platform vehicle 1000, thereby raising/lowering the platform vehicle 1000 relative to the first rack.

Similarly, while in the extended position (or in the second configuration), the second engagement assembly 1220 is configured to be engageable with a second rack engagement (not shown) of a second rack. Once engaged with the second rack engagement, a second drive motor 1220d may be selectively activated to apply an upward or downward force on the platform vehicle 1000, thereby raising/lowering the platform vehicle 1000 relative to the second rack.

Typically, the first drive motor 1210d and the second drive motor 1220d are driven in a manner such that the platform vehicle 1000 maintains a generally horizontal level when ascending/descending the racks.

The third engagement assembly 1230 and the fourth engagement assembly 1240 are similar to the first engagement assembly 1210 and the second engagement assembly 1220, respectively, and, therefore, will not be discussed separately in detail.

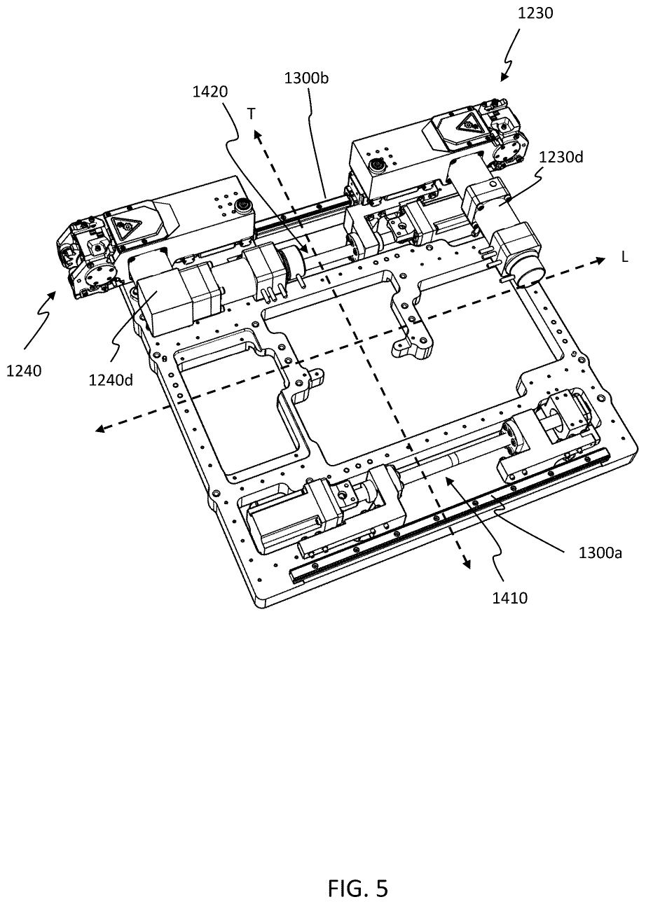

FIG. 5 depicts a perspective view of the platform vehicle 1000 with first engagement assembly 1210 and the second engagement assembly 1220 removed to show the first longitudinal spacing drive assembly 1410 in further detail. The first longitudinal spacing drive assembly 1410 may be fixed relative to the platform 1100. The first longitudinal spacing drive assembly 1410 generally extends in the longitudinal direction. The first longitudinal spacing drive assembly 1410 is located towards a transverse side of the platform vehicle 1000. As can be seen in FIG. 5, the first longitudinal spacing drive assembly 1410 may be located below the corresponding first engagement assembly 1210 and the second engagement assembly 1220, however, other arrangements are possible. For example, first longitudinal spacing drive assembly 1410 may be located at the side (e.g. inner side or outer side) or on top of the first engagement assembly 1210 and the second engagement assembly 1220.

The platform vehicle comprises a second longitudinal spacing drive assembly 1420. In a similar manner in structure and function to the first longitudinal spacing drive assembly 1410, the second longitudinal spacing drive assembly 1420 is connected to each of the third engagement assembly 1230 and the fourth engagement assembly 1240 and is configured to selectively move the third engagement assembly 1230 and the fourth engagement assembly 1240 along the second longitudinal guide rail 1300b (in the longitudinal direction L).

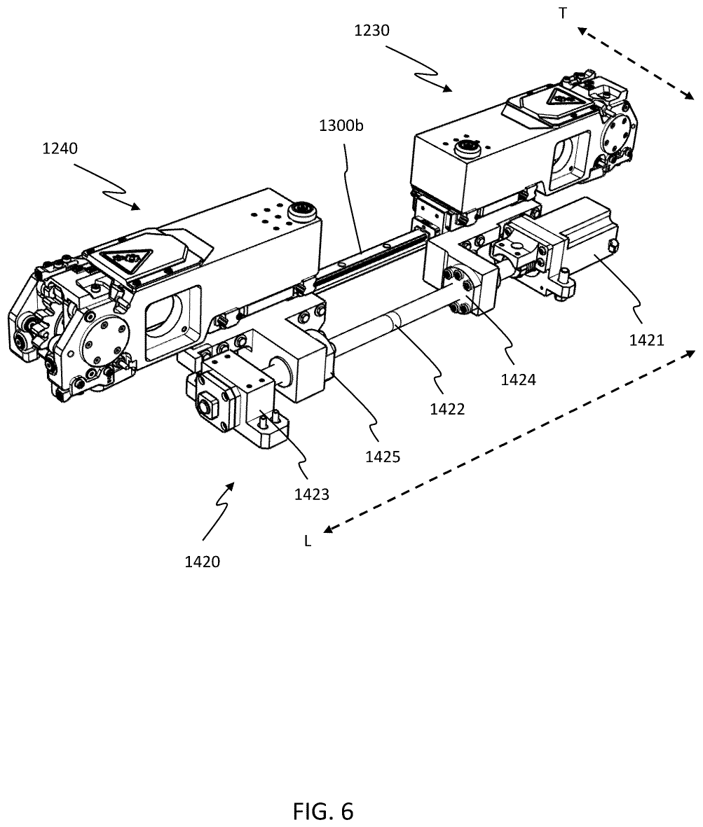

FIG. 6 depicts an isolated perspective view of the third engagement assembly 1230 and the fourth engagement assembly 1240 together with the corresponding the second longitudinal guide rail 1300b and the second longitudinal spacing drive assembly 1420. The second longitudinal spacing drive assembly 1420 is a ball-screw transmission configured to selectively drive the third engagement assembly 1230 and the fourth engagement assembly 1240 along the second longitudinal guide rail 1300b in opposite directions.

The second longitudinal spacing drive assembly 1420 comprises a motor 1421 (e.g. an electric motor) configured to selectively drive a ball-screw transmission rod 1422. The ball-screw transmission rod 1422 is held between the motor 1421 and a support 1423. The motor 1421 and support 1423 may be fixed relative to the platform 1100 such that the ball-screw transmission rod 1422 may only rotate relative to the platform 1100.

The ball-screw transmission rod 1422 comprises two opposing screw threads (not shown) where the third engagement assembly 1230 is engaged with a first of the two opposing screw threads and the fourth engagement assembly 1240 is engaged with a second of the two opposing screw threads. With such an arrangement, upon rotation of the ball-screw transmission rod 1422 by the motor 1421, the third engagement assembly 1230 and the fourth engagement assembly 1240 are driven/moved in opposite directions (either away from each other during rotation of the ball-screw transmission rod 1422 in a direction, or towards each other during rotation of the ball-screw transmission rod 1422 in the opposite direction).

The third engagement assembly 1230 is engaged with the corresponding screw thread with a ball nut assembly 1424. The ball nut assembly 1424 is fixed relative to the third engagement assembly 1230 such that motion of the ball nut assembly 1424 along the ball-screw transmission rod 1422 results in corresponding motion of the third engagement assembly 1230.

Similarly, fourth engagement assembly 1240 is engaged with the corresponding screw thread with a ball nut assembly 1425. The ball nut assembly 1425 is fixed relative to the fourth engagement assembly 1240 such that motion of the ball nut assembly 1424 along the ball-screw transmission rod 1422 results in corresponding motion of the fourth engagement assembly 1240.

The platform vehicle 1000 may be configured such that longitudinal movement of the third engagement assembly 1230 and the fourth engagement assembly 1240 is symmetrical across a line of symmetry extending in the transverse direction and intersecting with a center of the platform 1100. In this way, in any given configuration of the third engagement assembly 1230 and the fourth engagement assembly 1240 along the second longitudinal guide rail 1300b, an extended position of the third engagement assembly 1230 is equal in longitudinal distance from a center of the platform 1100 to an extended position of the fourth engagement assembly 1230. With such configurations, the platform 1100 is maintained in a central position between the third engagement assembly 1230 and the fourth engagement assembly 1240.

The first engagement assembly 1210 and the second engagement assembly 1220 together with the corresponding the first longitudinal guide rail 1300a and the first longitudinal spacing drive assembly 1410 are similar in structure and function to the above-described corresponding third engagement assembly 1230 and the fourth engagement assembly 1240 together with the corresponding the second longitudinal guide rail 1300b and the second longitudinal spacing drive assembly 1420. Accordingly, details are not repeated for brevity.

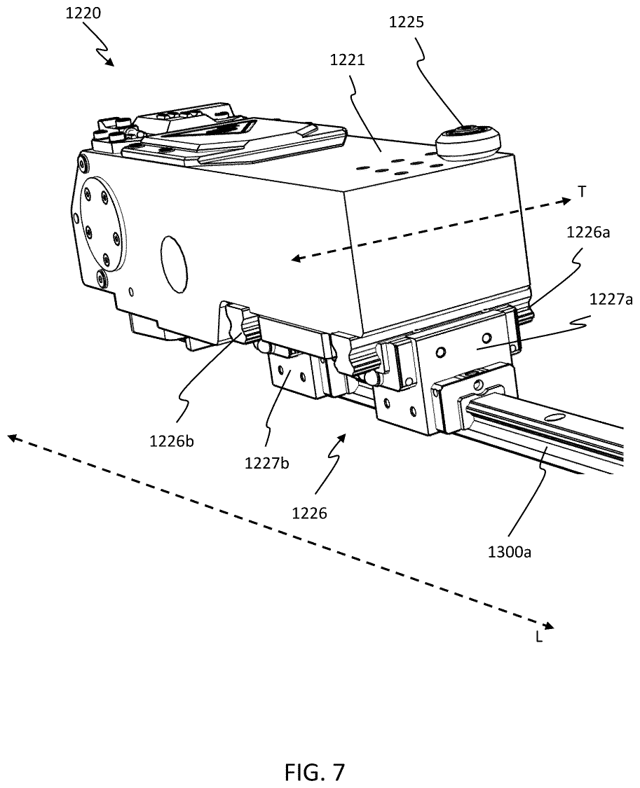

FIG. 7 depicts an isolated perspective view of the second engagement assembly 1220 together with (part of) the first longitudinal guide rail 1300a and a transverse guide assembly 1226.

The transverse guide assembly 1226 is configured to guide the second engagement assembly 1220 along the transverse direction T of the platform 1100. In the example shown in FIG. 7, the transverse guide assembly 1226 comprises two transverse guide rails 1226a, 1226b. Each of the transverse guide rails 1226a, 1226b extend in a transverse direction T and are spaced apart from each other along the longitudinal direction L. Each of the transverse guide rails 1226a, 1226b are fixed relative to the second engagement assembly 1220 such that the second engagement assembly 1220 and the transverse guide rails 1226a, 1226b move in unison.

Each of the two transverse guide rails 1226a, 1226b are received in guide blocks 1227a, 1227b. Each of the guide blocks 1227a, 1227b comprises a transverse recess to slidingly receive the respective transverse guide rails 1226a, 1226b. Each transverse recess extends in the transverse direction T. With such a configuration, the second engagement assembly 1220 is configured to be slidingly guided along the transverse direction T by the transverse guide assembly 1226.

Each of the guide blocks 1227a, 1227 also comprises a longitudinal recess configured to slidingly receive the corresponding first longitudinal guide rail 1300a. Each longitudinal recess extends in the longitudinal direction L (i.e. the transverse recess and the longitudinal recess are perpendicular with each other). With such a configuration, the second engagement assembly 1220 is configured to be slidingly guided along the longitudinal direction L by the first longitudinal guide rail 1300a.

The first longitudinal guide rail 1300a and/or the transverse guide rails 1226a, 1226b may optionally include stops to prevent the second engagement assembly 1220 exceeding a maximum and/or minimum longitudinal position and/or a maximum and/or minimum transverse position. In addition/alternatively, the platform vehicle may optionally further comprise a cam guide which is configured to constrain the longitudinal position and/or the transverse position of the second engagement assembly 1220. Further details on use of a cam guide are provided below.

The first longitudinal guide rail 1300a and the transverse guide assembly 1226 operate independently from each other. Accordingly, the second engagement assembly 1220 is moveable independently in both the longitudinal direction L and the transverse direction T.

In the example shown in FIG. 7, two guide blocks 1227a, 1227b are present. In other examples, a single guide block may be used to receive both transverse guide rails 1226a, 1226b.

In a similar manner to that described above in relation to the second engagement assembly 1220, the first engagement assembly 1210, third engagement assembly 1230, and the fourth engagement assembly 1240 are guided by corresponding longitudinal guide rails and corresponding transverse guide assemblies. Accordingly, details are not repeated for brevity.

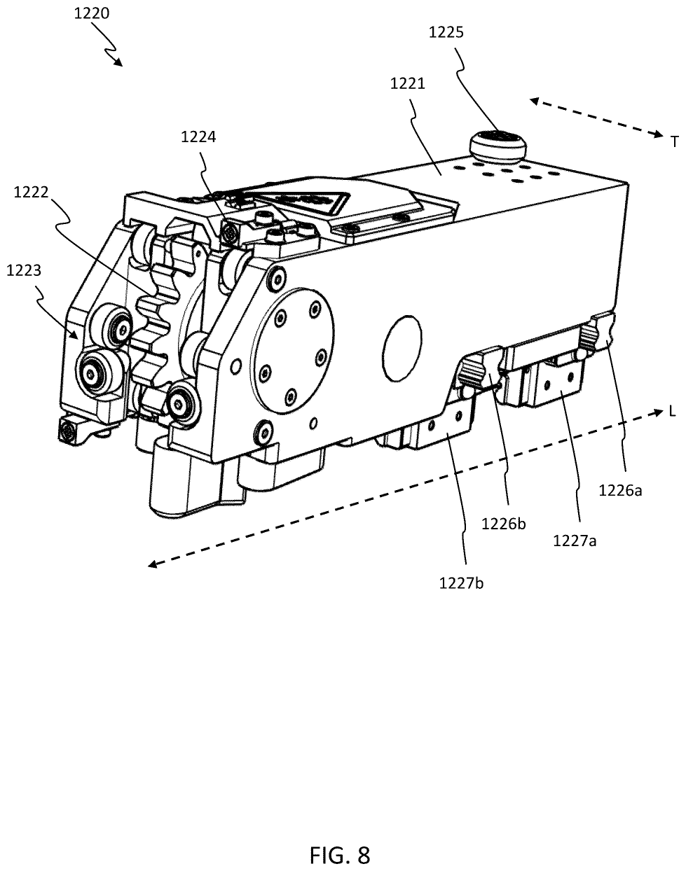

FIG. 7 also shows further details of the second engagement assembly 1220, with corresponding features being present in each of the first engagement assembly 1210, third engagement assembly 1230, and the fourth engagement assembly 1240. These are described also with reference to FIG. 8 which shows another isolated view of the second engagement assembly 1220.

The second engagement assembly 1220 comprises an engagement assembly body 1221. The engagement assembly body 1221 may be configured as the main body of the second engagement assembly 1220 to which other elements are fixed/housed. The engagement assembly body 1221 is generally a rectangular cuboid shape with a longitudinal axis being aligned with the longitudinal direction L.

The second engagement assembly 1220 also comprises a roller 1225. The roller 1225 is rotatably attached to the top of the engagement assembly body 1221. As described in further detail below, the roller 1225 is configured to be received in a cam guide which constrains the position of the second engagement assembly 1220.

Referring to FIG. 8, it is shown that the second engagement assembly 1220 further comprises a pinion 1222. The pinion 1222 is configured to engage a corresponding rack engagement (not shown) of a rack 101, 102, 103 of the warehouse 100. The corresponding rack engagement may be a linear gear. The pinion 1222 and the corresponding rack engagement may be a rack-and-pinion configuration.

The pinion 1222 is configured to be selectively driven by corresponding motor 1220d so as to be rotated (in either direction). In this manner, if the pinion 1222 is engaged with a corresponding rack engagement, an upward/downward force may be applied to the platform vehicle 1000.

The second engagement assembly 1220 also comprises an engagement roller assembly 1223. The engagement roller assembly 1223 is configured to align the pinion 1222 with the corresponding rack engagement (e.g. linear gear) as the second engagement assembly 1220 engages the corresponding rack engagement. The engagement roller assembly 1223 may also be configured to maintain alignment of the pinion 1222 with the corresponding rack engagement (e.g. linear gear) as the second engagement assembly 1220 (and the platform vehicle 1000 as a whole) moves up and down the rack 101, 102, 103.

As further detailed below, the engagement roller assembly 1223 may also be configured to transfer forces from the rack (e.g. the rack engagement) to the second engagement assembly 1220 in the longitudinal direction L and the transverse direction T.

The roller assembly 1223 may comprise any number of individual rollers, including a single roller.

The second engagement assembly 1220 further comprises a detector 1224. The detector 1224 is configured to detect once the second engagement assembly 1220 (e.g., in particular, the pinion 1222 and/or the engagement roller assembly 1223) has engaged the corresponding rack engagement. The detector 1224 may be an induction sensor, contact sensor, etc.

As discussed below, once at least detector 1224 senses that the second engagement assembly 1220 has engaged the corresponding rack engagement, the first longitudinal spacing drive assembly 1410 stops driving the second engagement assembly 1220.

Operation of the platform vehicle 1000 will now be discussed.

Robotic vehicle R is positioned (e.g. using wheels of the robotic vehicle R) between two racks (e.g. rack 102b and 103b as shown in FIG. 2) such that the first engagement assembly 1210 generally aligns (in the transverse direction T) with a rack engagement of the first rack, the second engagement assembly 1220 generally aligns (in the transverse direction T) with a rack engagement of the second rack, the third engagement assembly 1230 generally aligns (in the transverse direction T) with another rack engagement of the first rack and the fourth engagement assembly 1240 generally aligns (in the transverse direction T) with another rack engagement of the second rack. At this point, platform vehicle 1000 comes into engagement with the lower part 2000.

Thereafter, the first longitudinal spacing drive assembly 1410 is driven so as to extend each of the first engagement assembly 1210 and the second engagement assembly 1220 outwardly (in the longitudinal direction L) from a retracted/neutral position. The first engagement assembly 1210 and the second engagement assembly 1220 are guided along the first longitudinal guide rail 1300a.

Once the respective detectors (e.g. detector 1224 of second engagement assembly 1220) senses that the corresponding engagement assembly 1210, 1220 has engaged the respective rack engagement, the first longitudinal spacing drive assembly 1410 stops driving the engagement assemblies outwardly. In this configuration, the respective pinion (e.g. pinion 1222 of second engagement assembly 1220) is successfully engaged with the corresponding rack engagement (e.g. linear gear, not shown).

Optionally, the robotic vehicle R may be raised by an initial amount (e.g. by using drive motors 1210d, 1220d, 1230d, 1240d) whilst the first longitudinal spacing drive assembly 1410 and/or the second longitudinal spacing drive assembly 1420 are operated to prevent longitudinal movement of any of the engagement assemblies 1210, 1220, 1230, 1240. This initial movement may allow the engagement roller assemblies of each respective engagement assembly 1210, 1220, 1230, 1240 (e.g. engagement roller assembly 1223) to engage with the corresponding tracks in the racks. Thereafter, the first longitudinal spacing drive assembly 1410 and/or the second longitudinal spacing drive assembly 1420 may stop actuating.

As the first longitudinal spacing drive assembly 1410 is not actuating (not being driven/powered), in this configuration, each of the first engagement assembly 1210 and the second engagement assembly 1220 are free to move along the first longitudinal guide rail 1300a (e.g. after the initial ascending of the robotic vehicle R detailed above). In certain embodiments, if the first longitudinal spacing drive assembly 1410 is not actuating, each of the first engagement assembly 1210 and the second engagement assembly 1220 are free to move along the first longitudinal guide rail 1300a with little or no resistance from the first longitudinal spacing drive assembly 1410.

A similar process is carried out with the second longitudinal spacing drive assembly 1420 to drive the third engagement assembly 1230 and the fourth engagement assembly 1240.

Once all four engagement assemblies 1210, 1220, 1230, 1240 are engaged with their corresponding rack engagements, the platform vehicle 1000 may detach from the lower part 2000. Thereafter, the respective pinions (e.g. pinion 1222 of second engagement assembly 1220) are driven by the respective motors (e.g. motor 1220d) such that the platform vehicle 1000 is translated upwardly.

With such configurations, as all four engagement assemblies 1210, 1220, 1230, 1240 are free to move in the longitudinal direction L along their respective longitudinal guide rails 1300a, 1300b, any relative vertical inclination of the racks 101, 102, 103 results in movement of the corresponding engagement assemblies 1210, 1220, 1230, 1240 in the longitudinal direction L along the corresponding longitudinal guide rails 1300a, 1300b. In this manner, the four engagement assemblies 1210, 1220, 1230, 1240 are able to stay securely engaged with the respective rack engagements, even in the situation where one or more of the racks are vertically inclined.

As the engagement assemblies 1210, 1220, 1230, 1240 are engaged with the longitudinal spacing drive assemblies 1410, 1420 which are in the form of ball-screw transmissions, the platform vehicle 1000 may be maintained in a central location in the longitudinal direction L between the two racks. This may reduce the likelihood of the platform vehicle 1000 colliding the racks/goods stored thereon.

The first engagement assembly 1210 and the second engagement assembly 1220 are independently moveable from the third engagement assembly 1230 and the fourth engagement assembly 1240. For example, while the longitudinal spacing drive assemblies 1410, 1420 are not being driven (e.g. while the platform vehicle 1000 is ascending/descending the racks), the first engagement assembly 1210 and the second engagement assembly 1220 may be positioned independently from the third engagement assembly 1230 and the fourth engagement assembly 1240. With such configurations, the platform vehicle 1000 may engage and ascend/descend horizontally skewed racks. For example, racks which are horizontally skewed may have rack engagements on one horizontal side being closer than the rack engagements on the other horizontal side. As the first engagement assembly 1210 and the second engagement assembly 1220 may be positioned independently from the third engagement assembly 1230 and the fourth engagement assembly 1240, this skew may be tolerated during vertical movement of the platform vehicle 1000.

As the platform vehicle 1000 ascends/descends the racks, one or more of the rack engagements may be misaligned/deformed/bent in the transverse direction T. However, as each of the engagement assemblies 1210, 1220, 1230, 1240 are moveable in the transverse direction T along the respective transverse guides 1226a, 1226b, the four engagement assemblies 1210, 1220, 1230, 1240 are able to stay securely engaged with the respective rack engagements, even in the situation where one or more of the rack engagements/racks are horizontally deformed/bent.

In view of the above, generally, once the engagement assemblies 1210, 1220, 1230, 1240 are engaged with the respective rack engagements (e.g. linear gear) and the platform vehicle 1000 traverses vertically, at least some or all of the engagement assemblies 1210, 1220, 1230, 1240 are moveable in the longitudinal direction L and transverse direction T in reaction to displacement in the longitudinal direction L and transverse direction T of the rack engagement.

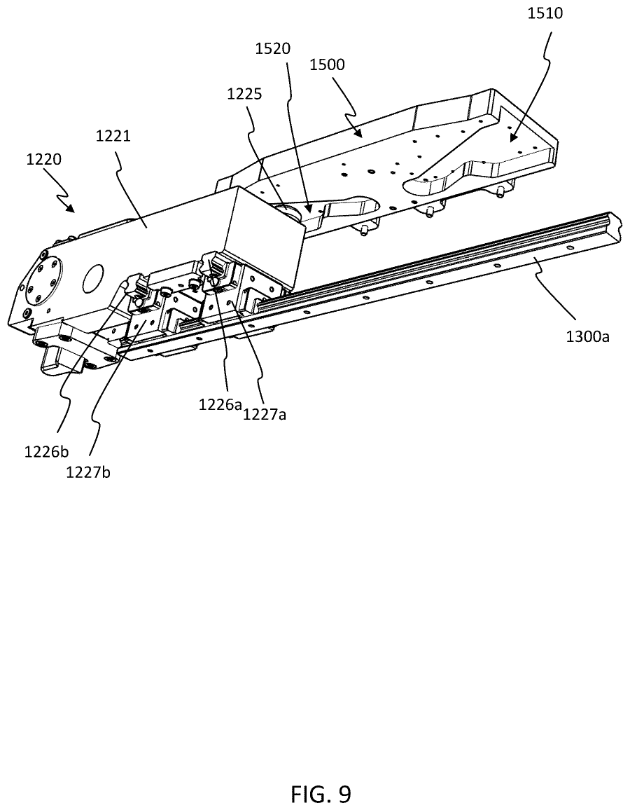

FIG. 9 depicts an isolated perspective view of the second engagement assembly 1220 on the corresponding first longitudinal guide rail 1300a. FIG. 9 shows an optional first cam assembly 1500. In other examples, first cam assembly 1500 may be omitted entirely. For a clearer view of the first cam assembly 1500, the first engagement assembly 1210 has been hidden from FIG. 9.

Generally, the first cam assembly 1500 is configured to constrain the movement of the first engagement assembly 1210 and the second engagement assembly 1220 along the respective transverse guides and first longitudinal guide rail 1300a.

The first cam assembly 1500 comprises a first cam guide 1510 configured to constrain the movement of the first engagement assembly 1210 and a second cam guide 1520 to constrain the movement of the second engagement assembly 1220. The first cam guide 1510 and the second cam guide 1520 may not intersect, as shown in FIG. 9. The first cam guide 1510 and the second cam guide 1520 are fixed relative to the platform 1100.

As noted above, the second engagement assembly 1220 comprises a roller 1225 which is configured to be received within the second cam guide 1520. The shape of the second cam guide 1520 together with the roller 1225 constrain the movement of the second engagement assembly 1220.

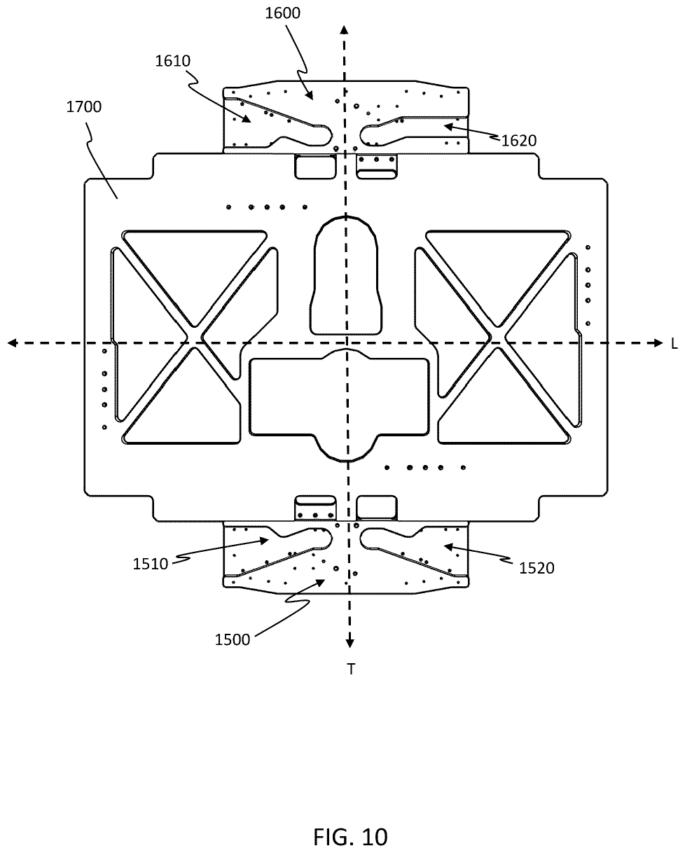

The platform vehicle also comprises a second cam assembly 1600 as shown in FIG. 10. The first cam assembly 1500 and the second cam assembly 1600 are fixedly connected to each other via a frame 1700. The frame may be fixedly connected to the platform 1100. Accordingly, generally, both the first cam assembly 1500 and the second cam assembly 1600 are fixed relative to the platform 1100.

The second cam assembly 1600 comprises a third cam guide 1610 and a fourth cam guide 1620. Similar to the first cam guide 1510 and the second cam guide 1520, the third cam guide 1610 is configured to constrain the movement of the third engagement assembly 1230. Similar to the first cam guide 1510 and the second cam guide 1520, the fourth cam guide 1620 is configured to constrain the movement of the fourth engagement assembly 1240, however, as detailed below, the shape of the fourth cam guide 1620 differs from the first cam guide 1510, the second cam guide 1520 and the third cam guide 1610.

The first cam guide 1510 and the second cam guide 1520 are generally symmetrical with each other across a line of symmetry along the transverse direction T and which passes through the center of the platform 1100.

The first cam guide 1510 and the third cam guide 1610 are generally symmetrical with each other across a line of symmetry along the longitudinal direction L and which passes through the center of the platform 1100.

Each of the cam guides 1510, 1520, 1610, 1620 are configured to constrain the movement of the respective engagement assembly 1210, 1220, 1230, 1240 such that, as the engagement assembly 1210, 1220, 1230, 1240 is moved towards its neutral position in the longitudinal direction L, the corresponding cam guide 1510, 1520, 1610, 1620 guides the engagement assembly 1210, 1220, 1230, 1240 towards its neutral position in the transverse direction T.

For example, as the first engagement assembly 1210 is moved from an extended position to the retracted/neutral position in the longitudinal direction L (e.g. by driving of the first longitudinal spacing drive assembly 1410), the first cam guide 1510 guides the first engagement assembly 1210 towards its neutral position in the transverse direction T.

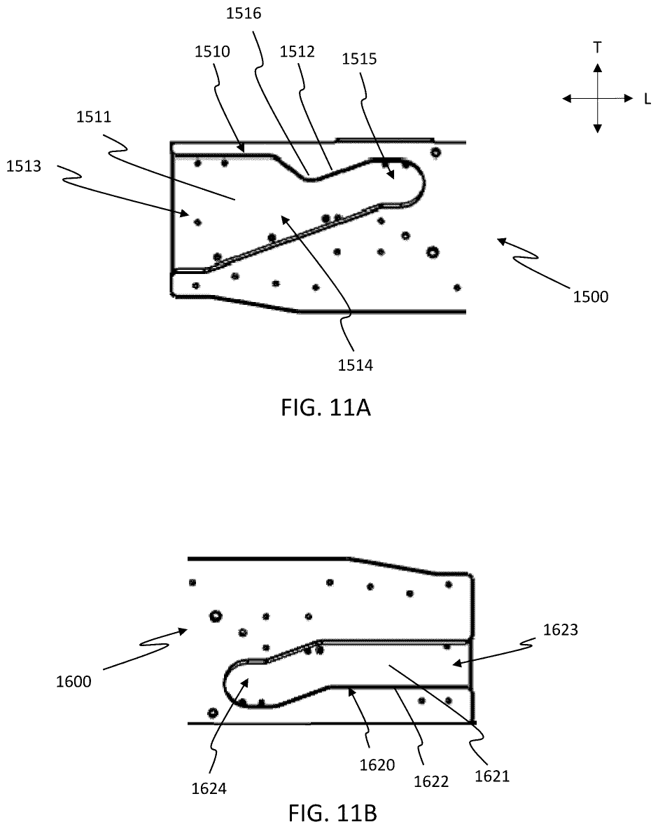

FIG. 11A shows a closer view of the first cam guide 1510 defined in the first cam assembly 1500. The first cam guide 1510 comprises a base 1511 which is generally planar. The base 1511 is delimited by a wall 1512 of the first cam guide 1510. The wall 1512 is configured to abut against the roller 1225 and therefore guide the roller 1225 (and the entire first engagement assembly 1210). In this manner, the wall 1512 together with the roller 1225 define a constrained area of movement for the first engagement assembly 1210.

The wall 1512 may not be closed and accordingly the first cam guide 1510 an opening area 1513 for the roller 1225 to enter/exit the first cam guide 1510. In this manner, the roller 1225 may be moved outside of the first cam guide 1510. However, in certain examples, the position of the first engagement assembly 1210 is also constrained by the transverse guide rails 1226a, 1226b and/or the first longitudinal guide rail 1330a (e.g. in the manner described above using stops on the rails) and/or limiters on any other part of the robotic vehicle R, such as frame 1700. Accordingly, the mouth 1513 may be configured to be of such a transverse width (in the transverse direction T) such that it is greater than or equal to the maximum transverse displacement of the roller 1225. Therefore, upon retraction of the first engagement assembly 1210 it is ensured that the roller 1225 is eventually moved into the first cam guide 1510.

The first cam guide 1510 also defines a narrowing portion 1514. The transverse distance between the wall 1512 in the narrowing portion 1514 is smaller at the portion closer to the central point of the platform 1100 than the portion further from the central point of the platform 1100. With such a narrowing portion 1514, as the first engagement assembly 1210 is moved from an extended position to the retracted/neutral position in the longitudinal direction L the position of the first engagement assembly 1210 is constrained to a narrower transverse region.

The first cam guide 1510 also defines a neutral portion 1515. The neutral portion 1515 is the portion of the first cam guide 1510 which is closest to the longitudinal central point of the platform 1100. When the roller 1225 is received in the neutral portion 1515, the first engagement assembly 1210 is in the neutral position (in both the longitudinal direction L and the transverse direction T).

The wall 1511 of the first cam guide 1510 also defines a notch 1516. The notch is positioned such that upon movement of the roller 1225 from the neutral portion 1515 outwardly, the roller 1225 transversely aligns with a central portion of the opening area 1513 when the roller exits the opening area 1513. In certain examples, the notch is positioned such that upon movement of the roller 1225 from the neutral portion 1515 outwardly, the roller 1225 transversely aligns with a transverse center point of the opening area 1513 when the roller exits the opening area 1513.

The second cam guide 1510 and the third cam guide 1610 are similar to the first cam guide 1510 and therefore details are not repeated for brevity.

FIG. 11B shows a closer view of the fourth cam guide 1620 defined in the second cam assembly 1600. The fourth cam guide 1620 comprises a base 1621 which is generally planar. The base 1621 is delimited by a wall 1622 of the fourth cam guide 1620. The wall 1622 is configured to abut against the roller of the fourth engagement assembly 1240 and therefore guide the roller (and the entire fourth engagement assembly 1240). In this manner, the wall 1622 together with the roller define a constrained area of movement for the fourth engagement assembly 1240.

Generally, the fourth cam guide 1620 constrains the position of the fourth engagement assembly 1240 to a greater extent than the other cam guides 1510, 1520, 1610 with the respective engagement assemblies 1210, 1220, 1230.

In particular, for example, an opening area 1623 of the fourth cam guide 1620 is transversely narrower than the opening area 1513 of the first cam guide 1510. The opening area 1623 may have a transverse width which is equal to (with a tolerance) the width of the roller of the fourth engagement assembly 1240. In other examples, the wall 1622 of the fourth cam guide 1620 may be closed such that the roller of the fourth engagement assembly 1240 cannot exit the fourth cam guide 1620.

The fourth cam guide 1620 also defines a neutral portion 1624. The neutral portion 1624 is the portion of the fourth cam guide 1620 which is closest to the longitudinal central point of the platform 1100. When the roller is received in the neutral portion 1624, the fourth engagement assembly 1240 is in the neutral position (in both the longitudinal direction L and the transverse direction T).

As shown in FIG. 11B, the transverse width of the fourth cam guide 1620 is approximately the same across the length of the fourth cam guide 1620. The transverse width may be equal to (with a tolerance) the width of the roller of the fourth engagement assembly 1240. With such configurations, the fourth engagement assembly 1240 can only take one transverse position for a given longitudinal position.

Referring again to FIG. 10, the neutral portions (not marked) of the first cam guide 1510 and the second cam guide 1520 are approximately aligned in the transverse direction. Accordingly, the neutral position of the first engagement assembly 1210 and the neutral position of the second engagement assembly 1220 are aligned in the transverse direction.

The neutral portions (not marked) of the third cam guide 1610 and the fourth cam guide 1620 are approximately aligned in the transverse direction. Accordingly, the neutral position of the third engagement assembly 1230 and the neutral position of the fourth engagement assembly 1240 are aligned in the transverse direction.

The neutral portions (not marked) of the first cam guide 1510 and the second cam guide 1520 are oppositely offset equally in the longitudinal direction L from the longitudinal center point of the platform 1100. Accordingly, the neutral position of the first engagement assembly 1210 and the neutral position of the second engagement assembly 1220 are oppositely offset equally in the longitudinal direction L from the longitudinal center point of the platform 1100.

The neutral portions (not marked) of the third cam guide 1610 and the fourth cam guide 1620 are oppositely offset equally in the longitudinal direction L from the longitudinal center point of the platform 1100. Accordingly, the neutral position of the third engagement assembly 1230 and the neutral position of the fourth engagement assembly 1240 are oppositely offset equally in the longitudinal direction L from the longitudinal center point of the platform 1100.

Operation of the platform vehicle 1000 with optional cam assemblies 1500, 1600 will now be discussed.

Robotic vehicle R is positioned (e.g. using wheels of the robotic vehicle R) between two racks (e.g. rack 102b and 103b as shown in FIG. 2) such that the first engagement assembly 1210 generally aligns (in the transverse direction T) with a rack engagement of the first rack, the second engagement assembly 1220 generally aligns (in the transverse direction T) with a rack engagement of the second rack, the third engagement assembly 1230 generally aligns (in the transverse direction T) with another rack engagement of the first rack and the fourth engagement assembly 1240 generally aligns (in the transverse direction T) with another rack engagement of the second rack. At this point, platform vehicle 1000 comes into engagement with the lower part 2000.

Thereafter, the first longitudinal spacing drive assembly 1410 is driven so as to extend each of the first engagement assembly 1210 and the second engagement assembly 1220 outwardly (in the longitudinal direction L) from a retracted position. The first engagement assembly 1210 and the second engagement assembly 1220 are guided along the first longitudinal guide rail 1300a.

Once the respective detectors (e.g. detector 1224 of second engagement assembly 1220) senses that the corresponding engagement assembly 1210, 1220 has engaged the respective rack engagement, the first longitudinal spacing drive assembly 1410 stops actuating. In this configuration, the respective pinion (e.g. pinion 1222 of second engagement assembly 1220) is successfully engaged with the corresponding rack engagement (e.g. linear gear, not shown).

As the first longitudinal spacing drive assembly 1410 is not actuating (not being driven/powered), in this configuration, each of the first engagement assembly 1210 and the second engagement assembly 1220 are free to move along the first longitudinal guide rail 1300a. In certain embodiments, if the first longitudinal spacing drive assembly 1410 is not actuating, each of the first engagement assembly 1210 and the second engagement assembly 1220 are free to move along the first longitudinal guide rail 1300a with little or no resistance from the first longitudinal spacing drive assembly 1410.

A similar process is carried out with the second longitudinal spacing drive assembly 1420 to drive the third engagement assembly 1230 and the fourth engagement assembly 1240.

Once all four engagement assemblies 1210, 1220, 1230, 1240 are engaged with their corresponding rack engagements, the platform vehicle 1000 may detach from the lower part 2000. Thereafter, the respective pinions (e.g. pinion 1222 of second engagement assembly 1220) are driven by the respective motors (e.g. motor 1220d) such that the platform vehicle 1000 is translated upwardly.

With such configurations, as all four engagement assemblies 1210, 1220, 1230, 1240 are free to move in the longitudinal direction L along their respective longitudinal guide rails 1300a, 1300b, any relative vertical inclination of the racks 101, 102, 103 results in movement of the corresponding engagement assemblies 1210, 1220, 1230, 1240 in the longitudinal direction L along the corresponding longitudinal guide rails 1300a, 1300b. In this manner, the four engagement assemblies 1210, 1220, 1230, 1240 are able to stay securely engaged with the respective rack engagements, even in the situation where one or more of the racks are vertically inclined.

Once any required goods are retrieved/deposited, the platform vehicle 1000 descends the racks and re-attaches to the lower part 2000. The four engagement assemblies 1210, 1220, 1230, 1240 are disengaged with their corresponding rack engagements. The four engagement assemblies 1210, 1220, 1230, 1240 are retracted from the respective extended positions to the respective neutral positions. Upon retraction, the corresponding cam guides 1510, 1520, 1610, 1620 constrain the position of the four engagement assemblies 1210, 1220, 1230, 1240 so as to return them to the neutral positions (where the rollers are received in the neutral portions of the cam guides 1510, 1520, 1610, 1620).

Thereafter, the robotic vehicle R may relocate to a different location between two racks (e.g. rack 101d and rack 102d). Due to the cam guides 1510, 1520, 1610, 1620 the four engagement assemblies 1210, 1220, 1230, 1240 are reliably located in the same (and predetermined) positions each time a full retraction to the neutral positions is performed. Accordingly, when attempting to engage the new racks 101d, 102d, the four engagement assemblies 1210, 1220, 1230, 1240 can be extended in a consistent and reliable manner.

Specifically, due to the cam guides 1510, 1520, as the first engagement assembly 1210 and the second engagement assembly 1220 are extended outwardly, the transverse positions thereof are constrained due to the respective cam guides 1510, 1520. In particular, due to the notches of the cam guides 1510, 1520, the respective rollers exit the cam guides 1510, 1520 at a predetermined position (e.g. at a central point of the opening, as discussed above). These predetermined positions can be used to reliably align the first engagement assembly 1210 and the second engagement assembly 1220 with the respective rack engagement of rack 101d and rack 102d. A similar mechanism is used to align the third engagement assembly 1230 and the fourth engagement assembly 1240, however, the fourth cam guide 1620 does not require a notch as it limits the movement of the corresponding roller to only one transverse position for every longitudinal position.

The cam guides disclosed herein are entirely optional. Therefore, there is disclosed a platform vehicle without cam guides 1510, 1520, 1610, 1620. It is contemplated that other mechanisms (such as motors, drives, etc.) can be used to reset the position of the four engagement assemblies 1210, 1220, 1230, 1240.

Furthermore, the longitudinal guides and transverse guides of the platform vehicle 1100 are also entirely optional. It is contemplated that other mechanisms (e.g. wheels, steering, etc.) may be used to position the four engagement assemblies 1210, 1220, 1230, 1240.

What is claimed is:

1. A platform vehicle for a robotic system of a warehouse, the platform vehicle configured to vertically traverse racks of the warehouse, the platform vehicle comprising:
a platform defining a longitudinal direction and a transverse direction, the platform being moveable vertically up and down two racks of the warehouse disposed on opposite sides of the platform and spaced apart along the longitudinal direction; and
an engagement system configured to engage with the two racks of the warehouse, the engagement system comprising:
a first engagement assembly configured to selectively engage a first rack engagement of a first rack of the two racks;
a second engagement assembly configured to selectively engage a second rack engagement of a second rack of the two racks, the first engagement assembly and the second engagement assembly being disposed on opposite sides of the platform and spaced apart along the longitudinal direction;
a longitudinal guide configured to guide the first engagement assembly and the second engagement assembly along the longitudinal direction of the platform;
a longitudinal spacing drive assembly configured to selectively drive the first engagement assembly and the second engagement assembly along the longitudinal guide such that the first engagement assembly and the second engagement assembly are moveable between a first spacing configuration and a second spacing configuration, a longitudinal distance between the first engagement assembly and the second engagement assembly being greater in the second spacing configuration than in the first spacing configuration, the first engagement assembly and the first rack engagement being engageable in the second spacing configuration and the second engagement assembly and the second rack engagement being engageable in the second spacing configuration; and
a transverse guide system configured to guide the first engagement assembly along the transverse direction of the platform and the second engagement assembly along the transverse direction of the platform, the transverse guide system being configured such that: i) whilst the first engagement assembly and the first rack engagement are engaged and the platform vehicle traverses vertically, the first engagement assembly is moveable along the transverse guide system in reaction to displacement in the transverse direction of the first rack engagement; and ii) whilst the second engagement assembly and the second rack engagement are engaged and the platform vehicle traverses vertically, the second engagement assembly is moveable along the transverse guide system in reaction to displacement in the transverse direction of the second rack engagement.

2. The platform vehicle of claim 1, wherein the transverse guide system is configured to guide the first engagement assembly along a first linear path in the transverse direction of the platform and the second engagement assembly along a second linear path in the transverse direction of the platform, the first linear path and the second linear path being spaced apart along the longitudinal direction.

3. The platform vehicle of claim 1, wherein the first and/or second engagement assembly comprises at least one guide recess receiving a corresponding guide rail of the transverse guide system.

4. The platform vehicle of claim 1, wherein the first and/or second engagement assembly comprises at least one guide rail received in a corresponding guide recess of the transverse guide system.

5. The platform vehicle of claim 1, wherein the transverse guide system comprises:
a first transverse guide assembly configured to guide the first engagement assembly along the transverse direction of the platform, the first transverse guide assembly being configured such that whilst the first engagement assembly and the first rack engagement are engaged and the platform vehicle traverses vertically, the first engagement assembly is moveable along the first transverse guide assembly in reaction to displacement in the transverse direction of the first rack engagement; and
a second transverse guide assembly configured to guide the second engagement assembly along the transverse direction of the platform, the second transverse guide assembly being configured such that whilst the second engagement assembly and the second rack engagement are engaged and the platform vehicle traverses vertically, the second engagement assembly is moveable along the second transverse guide assembly in reaction to displacement in the transverse direction of the second rack engagement.

6. The platform vehicle of claim 1, wherein the longitudinal spacing drive assembly is configured to selectively drive the first engagement assembly and the second engagement assembly from the first spacing configuration to the second spacing configuration and configured to detect engagement of both the first engagement assembly with the first rack engagement and the second engagement assembly with the second rack engagement, and wherein upon detection of both, the longitudinal spacing drive assembly is configured to stop driving the first engagement assembly and the second engagement assembly between the first spacing configuration and the second spacing configuration.

7. The platform vehicle of claim 6, wherein the longitudinal spacing drive assembly is configured such that when the longitudinal spacing drive assembly is not driving the first engagement assembly and the second engagement assembly between the first spacing configuration and the second spacing configuration, the first engagement assembly and the second engagement assembly are free to move between the first spacing configuration and the second spacing configuration in reaction to displacement in the longitudinal direction of the first rack engagement and/or the second rack engagement whilst the platform vehicle vertically traverses the two racks.

8. The platform vehicle of claim 6, wherein the longitudinal spacing drive assembly is configured to detect engagement of the first engagement assembly with the first rack engagement and/or the second engagement assembly with the second rack engagement using at least one induction detector arranged to detect the presence of the respective rack engagement.

9. The platform vehicle of claim 1, wherein the longitudinal spacing drive assembly comprises a ball-screw transmission configured to selectively drive the first engagement assembly and the second engagement assembly between the first spacing configuration and the second spacing configuration.

10. The platform vehicle of claim 9, wherein the ball-screw transmission comprises a rod with two opposing screw threads, and wherein the first engagement assembly is driven by one of the opposing screw threads and the second engagement assembly is driven in the opposite direction by the other opposing screw thread.

11. The platform vehicle of claim 1, wherein the first rack engagement and/or the second rack engagement is a linear gear, and wherein the corresponding first engagement assembly and/or the second engagement assembly comprises at least one pinion configured to engage the corresponding linear gear.

12. The platform vehicle of claim 1, wherein the longitudinal guide and the transverse guide system operate independently from each other.

13. A method of vertically traversing racks of a warehouse with a platform vehicle of a robotic system, the platform vehicle comprising a platform defining a longitudinal direction and a transverse direction, the method comprising:
positioning the platform between two racks of the warehouse such that the two racks are disposed on opposite sides of the platform and spaced apart along the longitudinal direction;
extending, in the longitudinal direction, a first engagement assembly and a second engagement assembly of the platform vehicle along a longitudinal guide of the platform vehicle from a first spacing configuration to a second spacing configuration;
engaging the first engagement assembly and a first rack engagement of a first rack of the two racks in the second spacing configuration and engaging the second engagement assembly and a second rack engagement of a second rack of the two racks in the second spacing configuration;
moving the platform vehicle vertically with respect to the two racks such that the first engagement assembly and/or the second engagement assembly are moved, in the transverse direction, along a transverse guide system of the platform vehicle in reaction to displacement in the transverse direction of the first rack engagement and/or the second rack engagement.

14. The method of claim 13, wherein the transverse guide system guides the first engagement assembly along a first linear path in the transverse direction of the platform and the second engagement assembly along a second linear path in the transverse direction of the platform, the first linear path and the second linear path being spaced apart along the longitudinal direction.

15. The method of claim 13, wherein the first and/or second engagement assembly comprises at least one guide recess receiving a corresponding guide rail of the transverse guide system.

16. The method of claim 13, wherein the first and/or second engagement assembly comprises at least one guide rail received in a corresponding guide recess of the transverse guide system.

17. The method of claim 13, wherein once the first engagement assembly and the first rack engagement are engaged and once the second engagement assembly and the second rack engagement are engaged, the longitudinal and transverse positions of the first engagement assembly and the second engagement assembly are free to change in reaction to the longitudinal and transverse positions of the first rack engagement and the second rack engagement.

18. The method of claim 13, wherein once the first engagement assembly and the first rack engagement are engaged and once the second engagement assembly and the second rack engagement are engaged, the longitudinal and transverse positions of the first engagement assembly and the second engagement assembly are dictated solely by the longitudinal and transverse positions of the first rack engagement and the second rack engagement.

19. The method of claim 13, wherein the first rack engagement and/or the second rack engagement is a linear gear, and wherein the corresponding first engagement assembly and/or the second engagement assembly comprises at least one pinion configured to engage the corresponding linear gear.

20. The method of claim 13, wherein the longitudinal guide and the transverse guide system operate independently from each other.
